(19) United States
(12) Patent Application Publication
(10) Pub. No.: US 2013/0064302 A1
(43) Pub. Date: Mar. 14, 2013

(54) VIDEO COMPRESSION CODING DEVICE AND DECODING DEVICE APPLIED WITH MOTION COMPENSATION TECHNIQUE USING SELECTIVE REFERENCE FRAME, AND METHOD FOR DETERMINING SELECTIVE REFERENCE FRAME FOR MOTION COMPENSATION

(71) Applicants: Jean Koh, Seongnam-si (KR); Jae Deok An, Uijeongbu-si (KR); Seong Hoon Kim, Seoul (KR); In Kwon Kim, Gwangmyeong-si (KR)

(72) Inventors: Jean Koh, Seongnam-si (KR); Jae Deok An, Uijeongbu-si (KR); Seong Hoon Kim, Seoul (KR); In Kwon Kim, Gwangmyeong-si (KR)

(73) Assignee: GALAXIA COMMUNICATIONS CO., LTD., Seoul (KR)

(21) Appl. No.: 13/699,075

(22) PCT Filed: May 20, 2010
(86) PCT No.: PCT/KR2010/003178

§ 371 Date: Nov. 20, 2012

(51) Int. Cl. H04N 7/32

(52) U.S. Cl. 375/240.16; 375/E07.123

(57) ABSTRACT

Disclosed is a method of generating a reference frame of a video CODEC for implementing motion compensation through motion estimation. The present invention is to increase compression efficiency by additionally creating various reference frames applied to an intentional motion blur and a deblur filtering, and selecting reference frame having small residual frame data during execution of the motion estimation as final reference frames among original reference frames and various reference frames additionally created.

### BACKGROUND OF THE INVENTION

1. Field of the Invention

The present invention relates to a method of generating a reference frame of a video CODEC for implementing motion compensation through motion estimation, and more particularly, to a method that can increase compression efficiency of a video CODEC by additionally creating a reference frame to which motion blur noise occurring due to motion of a video input apparatus such as a camera, or motion of an object is added, and a reference frame from which the motion blur noise is removed besides an existing or original reference frame, and compensating for motion by selecting a reference frame having much better efficiency from a plurality of reference frames.

2. Prior Art

In general, as shown in FIG. 1, a video coder to which a motion compensation method using motion estimation is applied includes a subtractor 10 for obtaining a difference signal between an input video (frames) and a motion-compensated video signal; a transform unit 20 for transforming the difference signal obtained by the subtractor 10 in accordance with a predetermined function; a quantization unit 30 for quantizing a frame signal transformed by the transform unit 20; an entropy coding unit 40 for coding frame information quantized by the quantization unit 30; and a motion compensation means for compensating for motion by performing inverse signal processing on the frame signal quantized by the quantization unit 30.

The motion compensation means includes an inverse quantization unit 50 for performing inverse quantization on the video signal quantized by the quantization unit 30; an inverse transform unit 60 for performing an inverse transform on signal transformed by the transform unit 20; an adder 70 for generating a frame reconstructed from an inverse transformed frame by the inverse transform unit 60 by adding a motion-compensated frame; a frame memory 80; a motion estimation unit 90 for generating a motion vector by estimating motion from a reference frame of a previous frame or a future frame to be inputted; and a motion compensation unit 100 for compensating for motion by using the motion vector generated from the motion estimation unit 90.

The input frame can be classified into an intra-frame and an inter-frame. The inter-frame is used to increase compression efficiency by selecting a frame before or after a currently input frame as a reference frame, performing motion estimation on the selected frame, and sequentially performing a transform, a quantization, and entropy coding on a residual frame.

When the next frame is necessary the reference frame, the reconstructed frame is generated through the inverse quantization and the inverse transform before the entropy coding, and the generated decoded frame is used as the reference frame.

In the case of H.264, a higher-definition reference frame can be obtained by configuring a deblocking filter after the inverse transform unit 60.

Here, the transform of the transform unit 20 is used a Discrete Cosine Transform (DCT) in the case of Moving Picture Experts Group 4 (MPEG4) part 2 is used. An entropy coding of the entropy coding unit 40 is used Variable Length Coding (VLC).

In the case of H.264/Advanced Video Coding (H.264/AVC), an integer transform may be used as the transform, and context-based adaptive VLC (CAVLC) or context-based adaptive binary arithmetic coding (CABAC) may be used as the entropy coding. Also, the deblocking filter may be used.

In general, respective frame of resultant images captured by a video apparatus generates motion blurs of a certain direction occur in a considerable number of frames due to the number of frames per second (FPS) of a camera, external factors such as shutter speed, movement of a photographing apparatus, shaking of the hand and the like, or to movement of an object to be photographed and the like.

When motion estimation is performed on the above-described images, if there is motion blurring on reference frames, but there is no motion blurring on input frames, or if there is no motion blurring on the reference frames, but there is motion blurring on the input frames, a residual frame value is set to be large, resulting in low compression efficiency.

### SUMMARY OF THE INVENTION

The objective of present invention is to increase compression efficiency by additionally creating various reference frames applied to an intentional motion blur and a deblur filtering, and selecting reference frame having small residual frame data during execution of the motion estimation as final reference frames among original reference frames and various reference frames additionally created.

In accordance with an aspect of the present invention, there is provided a video compression coder for performing motion estimation using a reference frame, including: one or more motion blur filters and one or more motion deblur filters to generate additional reference frame signals according to motion degrees and angles of original reference frames; frame memories configured for the motion blur filter and the motion deblur filter respectively; a reference frame generation control means to generate reference frames by selecting the motion blur filter and the motion deblur filter in accordance with a predetermined blur mode; a motion estimation and mode selection control means to perform motion estimation about all of the generated reference frames and the original reference frames, and select a blur mode to be applied to motion compensation by calculating costs of motion estimation processes; and a motion compensation means to perform motion compensation in accordance with the selected blur mode from the motion estimation and mode selection control means.

A motion estimation and compensation process of the coder of the present invention includes: a blur mode selection process of selecting the motion blur filter and the motion deblur filter to generate the additional reference frame signals in accordance with motion degrees and angles of the original reference frames; a filtering process of generating the reference frames by the motion blur filter and the motion deblur filter in accordance with the selected blur mode; a motion estimation process of performing motion estimation about the original reference frames and the reference frames generated through the filtering process; and a motion compensation process of compensating for motion by comparing costs occurring after the motion estimation and selecting a blur mode having a minimum value.

In accordance with another aspect of the present invention, in a video decoder for compensating for motion using a reference frame, there is provided a method including: a filter selection control means to extract blur mode information from a decoded video signal, and generate and control reference frames by selecting a motion blur filter or a motion deblur filter in accordance with the extracted blur mode information; one or more motion blur filters and one or more motion deblur filters to generate the reference frames; frame memories configured for the motion blur filter and the motion deblur filter respectively; and a motion compensation means to compensate for motion in accordance with motion information extracted from a generated stream and the generated reference frames.

A motion compensation process of the decoder of the present invention includes: a process of extracting the blur mode from the decoded video signal; a process of generating the reference frame through the motion blur filter or the motion deblur filter in accordance with information regarding the extracted blur mode; and a process of compensating for motion in accordance with the generated reference frame.

The present invention can further reduce temporal redundancy by increasing and decreasing the phenomenon of motion blur existing in most of the reference frames used for motion estimation and compensation in order to reduce temporal redundancy in a current video CODEC, and hence can increase compression efficiency of a coder by effectively reducing a bit generation amount.

The present invention is not limited only to MPEG4 and H.264/AVC as described in the above-described examples. The present invention can be applied to all CODECs having various algorithms even in entropy coding, such as DCT, Wavelet and the like in terms of a transform as an algorithm applicable to all video CODECs that performs inter estimation.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a configuration of a general video coder;

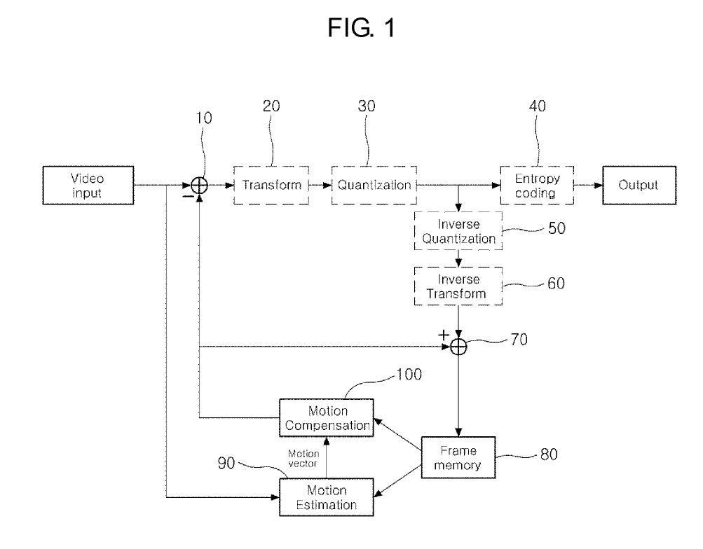

FIG. 2 is a block diagram illustrating a configuration of a video compression coding device applied with a motion compensation technique using a selective reference frame according to an exemplary embodiment of the present invention;

FIG. 3 is a diagram illustrating a process of a selective reference frame determination method for motion compensation according to an exemplary embodiment of the present invention; and

FIG. 4 is a block diagram illustrating a configuration of a video compression decoding device applied with a motion compensation technique using a selective reference frame according to an exemplary embodiment of the present invention.

### DETAILED DESCRIPTION OF EXEMPLARY EMBODIMENTS

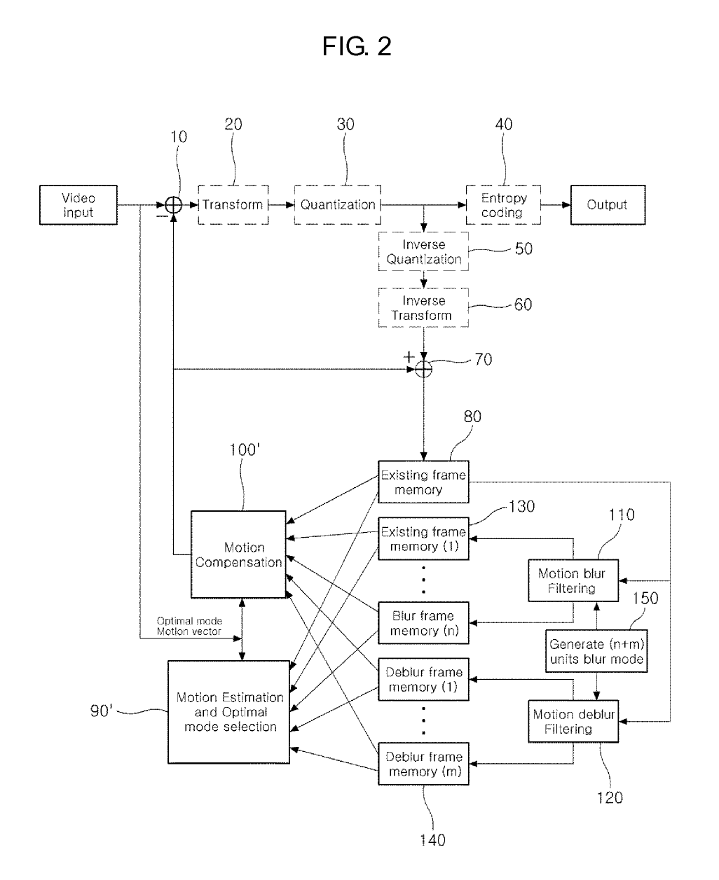

First of all, a video compression coding device applied with a motion compensation technique using a selective reference frame will be described with reference to an exemplary embodiment of the present invention as shown in FIG. 2. Hereinafter, the same reference numbers are used throughout the drawings to refer to the same or like parts.

The video compression coding device includes a subtractor 10 to obtain a difference signal between an input video (frames) and a motion-compensated video signal; a transform unit 20 to transform the difference signal obtained by the subtractor 10 in accordance with a predetermined function; a quantization unit 30 to quantize a frame signal transformed by the transform unit 20; an entropy coding unit 40 to code frame information quantized by the quantization unit 30; and a motion compensation means configured to compensate for motion by performing inverse signal processing on the frame signal quantized by the quantization unit 30.

The motion compensation means includes an inverse quantization unit 50 to perform inverse quantization on the frame signal quantized by the quantization unit 30; an inverse transform unit 60 to perform an inverse transform on the signal transformed by the transform unit 20; an adder 70 to generate a reconstructed frame from a frame which is performed the inverse transform by the inverse transform unit 60 by adding a motion-compensated frame; a frame memory 80; one or more motion blur filters 110 and one or more deblur filters 120 to generate additional reference frame signals in accordance with motion degrees and angles of original reference frames which is performed the inverse transform by the inverse transform unit 60; blur frame memories 130 and deblur frame memories 140 configured for the motion blur filter 110 and the motion deblur filter 120 respectively; a reference frame generation control unit 150 to generate reference frames by selecting the motion blur filter and the motion deblur filter in accordance with a predetermined mode; a motion estimation and mode selection control unit 90′ to perform motion estimation about all of the generated reference frames received from the blur frame memories 130 and the deblur frame memories 140, and the original reference frames received from the frame memory 80, calculate costs of motion estimation processes, and select a mode to be applied to motion compensation; and a motion compensation unit 100′ configured to compensate for motion in accordance with the mode selected by the motion estimation and mode selection control unit 90′.

An operation process in accordance with the exemplary embodiment of the present invention will be described in detail as follows.

As described in Prior Art, an inter-frame of an input video is used to increase compression efficiency by selecting a frame before or after a currently input frame as a reference frame, performing motion estimation on the selected frame, and sequentially performing a transform, quantization, and entropy coding on a residual frame.

When a next frame is necessary the reference frame, a reconstructed frame is generated through inverse quantization and an inverse transform before the entropy coding, and the generated reconstructed frame is used as the reference frame.

In this case, in consideration of the fact that compression efficiency may be decreased by motion blurring or deblurring, which may be shown in a current frame and reference frames, a motion estimation and compensation process in accordance with an exemplary embodiment of the present invention is aimed at increasing compression efficiency by performing motion blur and deblur filtering on reference frames to intentionally create additional reference frames, performing motion estimation on the reference frames including original reference frames, and selecting a reference frame having small residual frame data as a final reference frame.

The reference frame generation control unit 150 generates blur/deblur modes by selecting the motion blur filter 110 and the motion deblur filter 120 according to an internally set program mode.

That is, blur/deblur modes for (n+m) units are generated by selecting n motion blur filters 110 and m motion deblur filters 120.

A reconstructed frame generated by the inverse transform unit 60 is transferred to the motion blur filter 110 and the motion deblur filter 120 through the frame memory 80, and performs filtering by the motion blur filter 110 and the motion deblur filter 120 selected as described above, so that a plurality of reference frames are created.

Thereafter, the motion estimation and mode selection control unit 90′ selects an optimal mode by performing motion estimation about respective reference frame transferred from the frame memory 80, and reference frames transferred from the blur frame memories 130 and the deblur frame memories 140 in which is stored the reference frames after filtering by the motion blur filter 110 and the motion deblur filter 120, and calculating costs of execution steps.

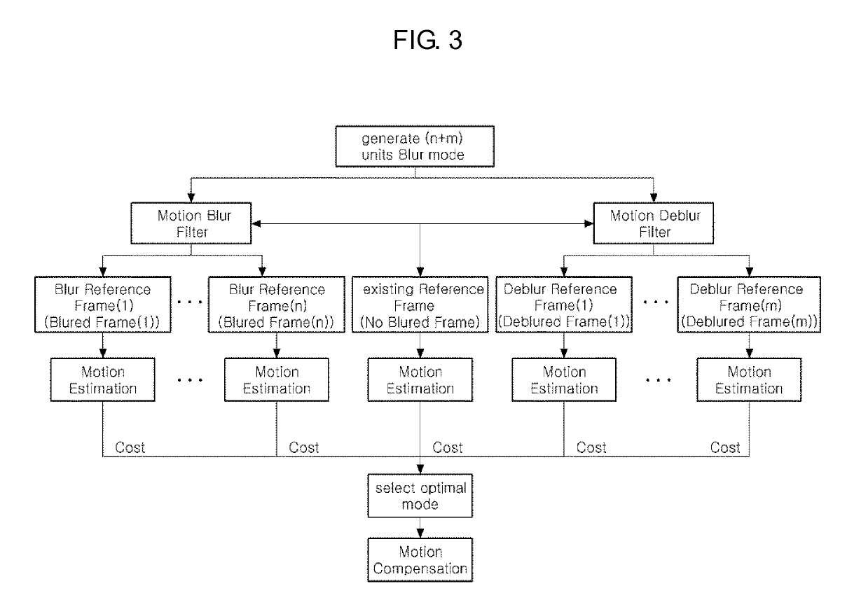

FIG. 3 illustrates a motion estimation and compensation process using reference frames as described above.

The motion estimation and compensation process includes: a motion mode selection process of selecting the motion blur filter and the motion deblur filter to generate additional reference frame in accordance with motion degrees and angles of original reference frames; a filtering process of generating the reference frames by the motion blur filter and the motion deblur filter in accordance with a selected motion mode; a motion estimation process of performing motion estimation about the original reference frames and the reference frames generated through the filtering process; and a motion compensation process of compensating for motion by comparing costs occurring after the motion estimation and selecting a motion mode having a minimum value.

In blur mode generation, the reference frame generation control unit 150 sets a motion magnitude (length or intensity), a motion direction, and a type of filter for an original reference frame, sets the blur mode for n units in the motion blur filter 110, and sets the deblur mode for m units in the motion deblur filter 120.

The motion magnitude (length or intensity) defines the number of filter taps to be used in a filter, the motion direction refers to a horizontal, vertical, or diagonal direction of a filter tap (supportable in all directions of 360 degrees). The information regarding the filter type indicates whether a uniform filter or a Point Spread Function (PSF) filter is used in accordance with the filter tap.

Mode-specific blurred frames are respectively created each mode in the blur mode set for the n modes, and mode-specific deblurred frames are respectively created each mode in the deblur mode set for the m modes.

In the motion estimation and mode selection control unit 90′, (n+m+1) motion estimation operations are performed with existing or original reference frames, calculates costs of respective execution step, and shall be selected a low-cost mode as an optimal mode.

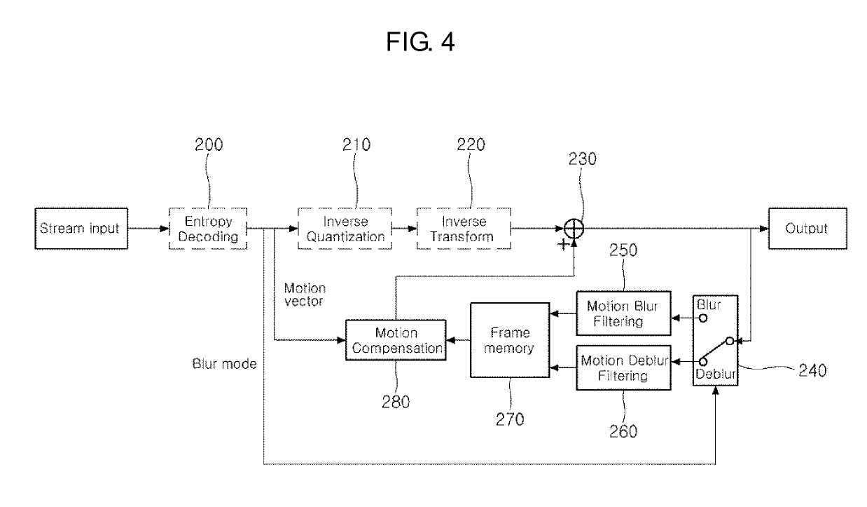

FIG. 4 illustrates a configuration of a video compression decoding device applied with a motion compensation technique using a selective reference frame according to an exemplary embodiment of the present invention.

The video compression decoding device includes a decoding unit 200 configured to perform entropy decoding about an input stream; an inverse quantization unit 210 to perform inverse quantization about a decoded frame signal from the decoding unit 200; an inverse transform unit 220 to perform a transform, inverse to the transform of the coding process, on the inverse quantized frame signal; an adder 230 to generate a reconstructed frame by adding a motion-compensated frame; a filter selection control unit 240 to extract blur mode information from the decoded frame signal from the decoding unit 200, and generate reference frames by selecting and controlling the motion blur filter 250 or the motion deblur filter 260 using the extracted information; one or more motion blur filters 250 and one or more motion deblur filters 260 to generate reference frames signals; a plurality of frame memories 270 configured for the motion blur filter 250 and the motion deblur filter 260 respectively; and a motion compensation unit 280 to compensate for motion using the reference frames transferred from the frame memories 270.

As described above, a decoder according to an exemplary embodiment of the present invention compensates for motion by extracting blur mode information input through a coding process on a coded video signal from the coder, generating reference frames through the extracted information, and performing motion estimation.

A decoding process includes a process of extracting a blur mode from a decoded video signal; a process of generating reference frames through the motion blur filter or the motion deblur filter in accordance with information regarding the extracted blur mode; and a process of compensating for motion in accordance with the generated reference frames.

The decoder decodes an inputted stream by performing the entropy decoding in the decoding unit 200, and obtains reconstructed frames from a motion-compensated frame by performing an inverse quantization and an inverse transform about the decoded input stream.

At this time, the filter selection control unit 240 extracts blur mode information inputted from a decoded video signal.

The blur mode information exists in the decoder in a form defined with the coder, whether to perform motion blur filtering or motion deblur filtering from the extracted blur mode information is selected, and the selection of a filter to be applied determines by obtaining information regarding a motion magnitude (length or intensity), a motion direction, and a type of filter.

From the above-described information, the filter selection control unit 240 obtains a new reference frame to which motion blur noise is added, or from which motion blur noise is removed, by performing motion blur filtering or motion deblur filtering about a decoded reference frame, and provides the new reference frame to the motion compensation unit 280.

The motion compensation unit 280 compensates for motion using the above-described reference frame.

What is claimed is:

1. A video compression coding device applied with a motion compensation technique using a selective reference frame in a video coder to which motion compensation using motion estimation is applied, comprising:
one or more motion blur filters and one or more motion deblur filters to generate additional reference frame signals from original reference frames;
frame memories configured for the motion blur filter and the motion deblur filter respectively;
a reference frame generation control means to generate reference frames by selecting the motion blur filter and the motion deblur filter in accordance with a predetermined blur mode;
a motion estimation and mode selection control means to perform motion estimation about all of the generated reference frames and the original reference frames, and select a blur mode to be applied to motion compensation by calculating costs of motion estimation processes; and
a motion compensation means configured to perform motion compensation in accordance with the selected blur mode from the motion estimation and mode selection control means.

2. The video compression coding device of claim 1, wherein the blur mode set in the reference frame generation control means includes information regarding a motion magnitude (length), a motion direction, and a type of filter.

3. A method of determining a selective reference frame for motion compensation in a motion estimation and compensation process for use in a compression coding device that estimates motion and compensates for the motion in accordance with the estimated motion, comprising:
a blur mode selection process of selecting a motion blur filter and a deblur filter to generate additional reference frames in accordance with motion degrees and angles of original reference frames;
a filtering process of generating the reference frames by the motion blur filter and the deblur filter in accordance with a selected blur mode;
a motion estimation process of performing motion estimation about the original reference frames and the reference frames generated through the filtering process; and
a motion compensation process of compensating for the motion by comparing costs occurring after the motion estimation and selecting a blur mode having a minimum value.

4. The method of claim 3, wherein, in the blur mode selection process, the blur mode includes information regarding a motion magnitude (length or intensity), a motion direction, and a type of filter.

5. A video compression decoding device applied with a motion compensation technique using a selective reference frame in a video decoder for performing motion compensation, comprising:
a filter selection control means to extract blur mode information from a decoded video signal, and generate and control reference frames by selecting a motion blur filter or a motion deblur filter in accordance with the extracted blur mode information;
one or more motion blur filters and one or more motion deblur filters to generate the reference frames;
frame memories configured for the motion blur filter and the motion deblur filter respectively; and
a motion compensation means to compensate for motion in accordance with motion information extracted from a generated stream and the generated reference frame.

6. The video compression decoding device of claim 5, wherein the blur mode information includes information regarding a motion magnitude (length or intensity), a motion direction, and a type of filter.

7. A video compression coding and decoding device applied with a motion compensation technique using a selective reference frame for implementing motion compensation through motion estimation,
wherein the video compression coding and decoding device:
generates additional reference frames by configuring one or more motion blur filters and one or more motion deblur filters with respect to original reference frames for motion estimation;
performs motion estimation on each of the generated reference frames and the additional reference frames;
compresses and codes a video by calculating costs of motion estimation processes, selecting a motion estimation value to be applied to motion compensation, and performing the motion compensation,
configures one or more motion blur filters and one or more motion deblur filters,
extracts filter information regarding motion blur or motion deblur from the compressed and coded video;
generates the reference frames by selecting the motion blur filter or the motion deblur filter in accordance with the extracted information; and
decoding a video by compensating for motion from the generated reference frames.
